(19) United States
(12) Patent Application Publication
(10) Pub. No.: US 2025/0027800 A1
(43) Pub. Date: Jan. 23, 2025

(54) FLUID FLOW MEASURING APPARATUS

(71) Applicant: The University of Warwick, Coventry, West Midlands (GB)

(72) Inventors: Steve DIXON, Coventry, West Midlands (GB); Andrew FEENEY, Coventry, West Midlands (GB); Lei KANG, Coventry, West Midlands (GB); Zhichao LI, Coventry, West Midlands (GB)

(73) Assignee: The University of Warwick, Coventry, West Midlands (GB)

(21) Appl. No.: 18/708,943

(22) PCT Filed: Nov. 9, 2022
(86) PCT No.: PCT/GB2022/052839

§ 371 Date: May 9, 2024

(30) Foreign Application Priority Data
Nov. 10, 2021 (GB) 2116130.2

(51) Int. Cl. G01F 1/667; G01F 1/66

(52) U.S. Cl. CPC G01F 1/667; G01F 1/662

(57) ABSTRACT

Apparatus (1) for measuring fluid flow is disclosed. The apparatus comprises first, second and third ultrasonic transducers (8), the second and third ultrasonic transducers arranged to receive an ultrasonic wave (13) from the first ultrasonic transducer, wherein the second and third ultrasonic transducers are spaced apart by a given distance. The apparatus further comprises a circuit (6) comprising a phase comparator (21) arranged to compare first and second signals (20) from the second and third ultrasonic transducers.

### FIELD

The present invention relates to a fluid flow measuring apparatus.

### BACKGROUND

Quantitative airflow monitoring or wind speed and direction measurements are required in a number of applications including the continuous monitoring of airflow in road tunnels to ensure quality of air within the tunnel, or the monitoring of airflow within a building space to ensure adequate ventilation. Each country has its own set of regulations about how airflow should be monitored. Measuring wind speed and direction, using a device as an anemometer has many applications in meteorology, shipping, transportation, use on wind turbines and other civil infrastructure such as buildings. There are also situations where one might want to measure the localised speed and direction of flow in a liquid, such as in a river or other body of water.

Having an accurate fluid flow measuring device with a design that is common to a number of applications can be extremely beneficial, as it can easily be adapted to different measurement applications. A device that also uses low-cost transducer and electrical components, but is still capable of measuring low fluid flow speeds is extremely useful as it facilitates the application of such devices in application fields where previously it would have been prohibitively expensive to do so. A fluid flow measuring device that was also capable of low electrical power consumption would offer further benefits, being capable of battery powered operation for long periods of time.

### SUMMARY

According to a first aspect of the present invention there is provided apparatus (or “a system”) comprising first, second and third ultrasonic transducers. The second and third ultrasonic transducers are arranged to receive an ultrasonic wave from the first ultrasonic transducer. The second and third ultrasonic transducers are spaced apart by a known distance (e.g., a predetermined distance or a calibrated (or “measured”) distance). The apparatus further comprises a circuit comprising a phase comparator arranged to compare first and second signals obtained from the second and third ultrasonic transducers respectively. The circuit may include amplifiers and/or signal shapers to condition respective signals generated by the second and third transducers for supply as the first and second signals to the phase comparator. The circuit can be used to determine a component of velocity of a fluid (such as air) moving in a direction along a line between the second and third ultrasonic transducers

Thus, the apparatus can be used to measure speed or velocity of fluid flow. The fluid is preferably air and so the apparatus may be operable as an anemometer.

The apparatus preferably comprises a signal generator, coupled to the first ultrasonic transducer, configured to cause the first ultrasonic transducer to generate a continuous wave (CW) ultrasonic wave.

The circuit may include a bias generator arranged to receive a signal from the phase comparator and generate a dc signal whose level depends on a phase difference between the first and second signals. The bias generator may comprise a low-pass filter. The bias generator may comprise an integrator.

The apparatus may also comprise an analogue-to-digital converter for digitising the dc signal. The analogue-to-digital converter may sample the dc signal at a rate no more than 128 kHz, preferably at a rate between 10 Hz and 128 kHz, more preferably between 100 Hz and 1 kHz.

The apparatus may further comprise a fourth ultrasonic transducer arranged to receive the ultrasonic wave from the first ultrasonic transducer. The fourth ultrasonic transducer may be spaced apart by a given distance from the second ultrasonic. The fourth ultrasonic transducer is not collinear with the second and third ultrasonic transducers. The circuit may comprise further phase comparator arranged to compare the first signal and a third signal from the fourth ultrasonic transducer.

Thus, the apparatus can be used to measure a direction, as well as speed, of the fluid flow.

The second, third and fourth ultrasonic transducers may be arranged in an equilateral triangle.

The apparatus may further comprise a respective amplifier (such as an operational amplifier) for each of the second, third and fourth ultrasonic transducers. Each amplifier may be configured to amplify a signal from a respective ultrasonic transducer having a gain set to saturate the signal.

The apparatus may further comprise a controller. The controller may comprise a signal generator configured to generate a signal for the first ultrasonic transducer. The controller may comprise an analogue to digital converter.

The circuit may be configured to convert ultrasonic wave signals from the second, third and, optionally, fourth ultrasonic transducers into square wave signals, and to generate a series of pulses by comparing two of the square wave signals so as to compare the ultrasonic wave signals received at the second, third and, optionally, fourth ultrasonic transducers.

The circuit may be further configured to generate a dc voltage output based on the width of pulses from the output of a logic gate used to measure the phase difference between two received signals.

The apparatus may further comprise a plurality of sets of ultrasonic transducers, each set comprising first, second, and third ultrasonic transducers.

According to a second aspect of the present invention there is provided apparatus comprising first, second and third ultrasonic transducers arranged along a surface and having respective transducer faces flush with the surface, a first reflector supported by the surface arranged so as to reflect a pressure wave emitted by the first ultrasonic transducer towards the second ultrasonic transducer and a second reflector supported by the surface arranged so as to reflect a pressure wave emitted by the first ultrasonic transducer towards the third ultrasonic transducer.

The circuit preferably comprises a phase comparator for comparing signals from the second and third ultrasonic transducers. The first, second and third ultrasonic transducers may be arranged collinearly. The first, second and third ultrasonic transducers may be arranged collinearly along a line which is parallel with a longitudinal axis of a tunnel in which the apparatus is installed.

The apparatus may further comprise a controller operatively connected to the second ultrasonic transducer and first and second amplifiers connected to the first and third ultrasonic transducers respectively. The controller may further comprise first and second signal shapers. The XOR logic gate may be operatively connected to the first and second signal shapers.

The apparatus may further comprise at least one diffuser (or “diffusing structure”). A diffuser may be an absorber, for example, in the form of a region of energy-absorbing material. A diffuser may take the form of scatterer, such as reflector or patterned surface, for directing ultrasonic waves away from the second and third transducers.

According to a third aspect of the present invention there is provide a method of determining speed and/or direction of a fluid flow. The method comprises transmitting an ultrasonic wave from a first ultrasonic transducer towards a second, third and, optionally, fourth ultrasonic transducers, and obtaining speed or velocity by comparing phase difference between first and second ultrasonic waves received by a first pair of the second, third and/or fourth ultrasonic transducers and, optionally, comparing phase difference between first and second ultrasonic waves received by a second pair of the second, third and/or fourth ultrasonic transducers.

Obtaining the speed and/or direction of the fluid flow may further comprise, for the first and second ultrasonic waves, converting ultrasonic wave signals received at the second, third and, optionally, fourth ultrasonic transducers into first and second square wave signals, and generating a first series of pulses by comparing the first and second square wave signals of the first pair of ultrasonic transducers and, optionally, generating a second series of pulses by comparing the first and second square wave signals of the second pair of ultrasonic transducers.

The first or second series of pulses may be generated by applying exclusive OR logic on the first and second square wave signals of the first pair of ultrasonic transducers and, optionally, on the first and second square wave signals of the second pair of ultrasonic transducers. Determining the speed or velocity of fluid moving past the second, third and, optionally, fourth ultrasonic transducers may be based on the widths of the pulses.

The method may further comprise generating a dc voltage output based on the rate of pulses in the first or second series of pulses.

### BRIEF DESCRIPTION OF THE DRAWINGS

Certain embodiments of the present invention will now be described, by way of example, with reference to the accompanying drawings, in which:

FIG. 1 is a perspective view of a system for measuring fluid flow in a space, such as a tunnel or room;

FIG. 2 is a schematic block diagram of the system shown in FIG. 1;

FIG. 3 is a perspective view of a first fluid flow measuring device;

FIG. 4 is a perspective view of a passage through the first fluid flow measuring device shown in FIG. 3;

FIG. 5 is a cross-section of the passage through the first fluid flow measuring device shown in FIG. 3 taken along a line A-A′;

FIG. 6 is a perspective view of another first fluid flow measuring device;

FIG. 7 is a schematic block diagram of a first ultrasonic flow-measuring system;

FIG. 8 is a schematic of waveforms of signals;

FIG. 9 is a schematic of waveforms of signals;

FIG. 10 is a schematic of waveforms of signals;

FIG. 11 is a schematic of waveforms of signals;

FIG. 12 is a schematic of a first integrator circuit;

FIG. 13 is a schematic of a second integrator circuit;

FIG. 14 is a schematic of a waveform signal;

FIG. 15 is a schematic of a waveform signal;

FIG. 16 is a schematic of a waveform signal;

FIG. 17 is a schematic of a waveform signal;

FIG. 18 is a perspective view of a second fluid flow measuring device;

FIG. 19 is a perspective view of a passage through the second fluid flow measuring device shown in FIG. 18;

FIG. 20 is a cross-section of a passage through the second fluid flow measuring device shown in FIG. 18 taken along a line B-B′;

FIG. 21 is a perspective view of another flow measuring device;

FIG. 22 is a schematic block diagram of a second ultrasonic flow-measuring system;

FIG. 23 is a perspective view of a third fluid flow measuring device;

FIG. 24 is a perspective view of a portion of the third fluid flow measuring device shown in FIG. 23;

FIG. 25 is a schematic view of transducer positions of the third fluid flow measuring device shown in FIG. 23;

FIG. 26 is a schematic block diagram of a third ultrasonic fluid flow measuring system;

FIG. 27 schematically illustrates a tunnel in which fluid flow measuring devices are installed for measuring air flow through the tunnel; and FIG. 28 schematically illustrates a room in which a fluid flow measuring device is installed for measuring air flow in the room.

### DETAILED DESCRIPTION OF CERTAIN EMBODIMENTS

### Introduction

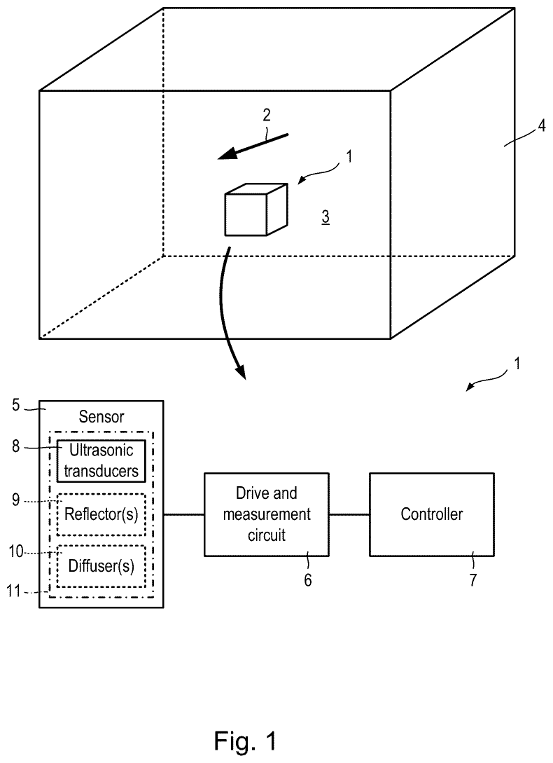

Referring to FIG. 1, a system 1 (or “apparatus”) for measuring fluid flow 2, in particular air flow, in a space 3 is shown. The space 3 may be partially enclosed or fully enclosed by one or structures 4, such as walls (which may include windows and doors), floors and ceilings. For example, the space 3 may be partially enclosed by a tunnel, pipe or conduit, or may be fully enclosed in a room (or in another enclosed space in a building), a vehicle or other closed space.

The system 1 comprises a sensor 5 (or “fluid flow measuring device”) and a circuit 6 (or “measurement circuit”) for providing drive signals to the sensor 5 and processing measurements from the sensor 5, and a controller 7.

The sensor 5 comprises plurality of ultrasonic transducers 8, one or more optional reflectors 9 and one or more optional diffusers 10 disposed in or supported by a structure 11 which may be an open structure, such as a frame, or closed structure, such as a housing or enclosure. The transducers 8 take the form of flexural ultrasonic transducers (also referred to as “unimorph ultrasonic transducers”) operating at, for example, 40 kHz.

The reflector(s) 9 may be used to re-direct ultrasonic waves from one transducer 8 towards another transducer 8, and a reflector 9 may take the form of a flat surface. A diffuser 10 may be absorber, for example, in the form of a region of energy-absorbing material. Alternatively, a diffuser 10 may take the form of scatterer, such as reflector or a patterned surface which is used to direct ultrasonic waves away from transducer(s) 8 and so discourage multiple reflections. For example, one transducer 8 may be mounted at a distal end of a frustum or other angled support (such as an arm) projecting from an inner wall of a passage such that it faces other transducers arranged along an opposite wall. Thus, any ultrasonic wave reflected back from the opposite wall or other transducers 8 is deflected off the angled wide wall(s) of the frustum generally away from the other transducers (rather than back towards them). Additionally or alternatively, an inner wall of a passage may be convoluted or suitably patterned and/or be formed from a material, for absorbing direct or reflected ultrasonic waves.

In a first arrangement, the transducers 8 are orientated generally in the same direction, and at least one reflector 9 is used to redirect ultrasonic waves from one transducer 8 (the “transmitter”) towards two other transducers 8 (the “receivers”) so each path from the transmitter to a respective receiver 8 includes reflection. In the first arrangement, the transmitter 8 is typically interposed between the receivers 8, for instance, collinearly or in an arc.

In a second arrangement, a transducer 8 (the “transmitter”) is orientated in the opposite direction to the other transducers 8 (the “receivers”) so it faces the receivers 8. Thus, each path from the transmitter 8 to a respective receiver 8 is direct. Diffuser(s) 10 may be provided to help reduce unwanted reflections.

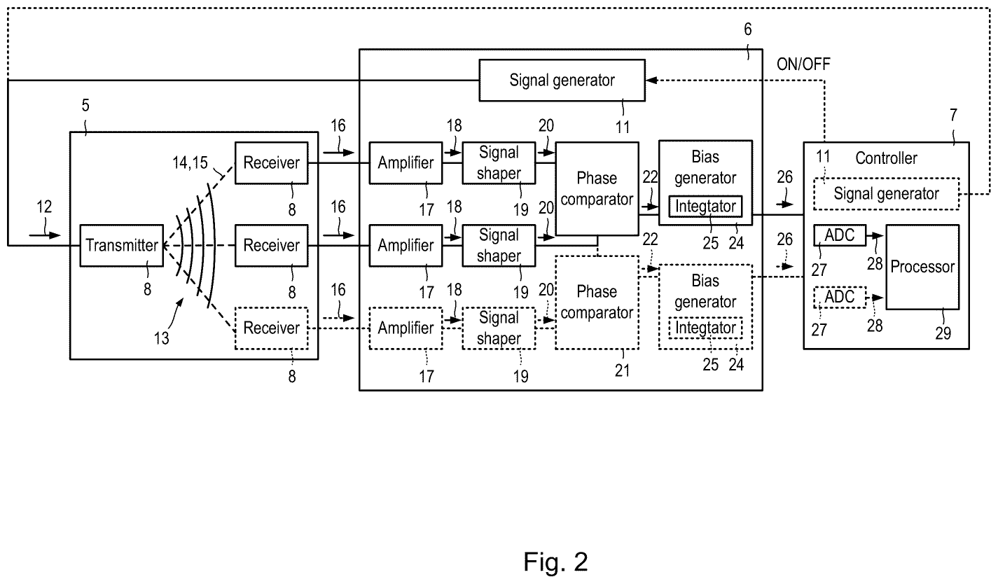

Referring also to FIG. 2, in both arrangements, a signal generator 11 is used to generate a time-varying signal 12 which is fed to the transmitter 8 which transmits a continuous-wave (CW) ultrasonic wave 13 which is received, via a direct path 14 or a reflected path 15, by the receivers 8 which generate respective signals 16 which are fed to the circuit 6. The signal generator 11 may be provided by the controller 7.

The time-varying signal 12 may be repeatedly switched on and off. The time-varying signal 12 is ON for sufficiently long, for example, at least 30 cycles, that the transducers 8 reach stable operating conditions. For an operating frequency of 40 kHz, this corresponds to a minimum ON time of 750 μs. The time-varying signal 12 is ON for between 100 and 10,000 cycles. Thus, a CW wave 13 an intermittently transmitted. 13.48.

The circuit 6 includes amplifiers 17 for generating amplified signals 18, optional signal shapers 19 for shaping the amplified signals 18 and generating shaped or conditioned signals 20 (“square-wave signals”). A pair of square-wave signals 20 are provided to a phase comparator 21 (or “phase detector”) for generating a phase difference signal 22. If there are more than one pairs of signals 20, then a phase comparator 21 may be provided for each pair of signals 20. The or each phase comparator 21 may take the form of an exclusive OR gate.

As will be explained in more detail later, the gains of the amplifiers 17 are set to be sufficiently high to saturate the outputs and so produce saturated or clipped signals 18. The signal shapers 19, which take the form of comparators which compares the saturated signals 18 to a threshold value, can be used to sharpen the rising and falling edges and thus produce square-wave signals 20.

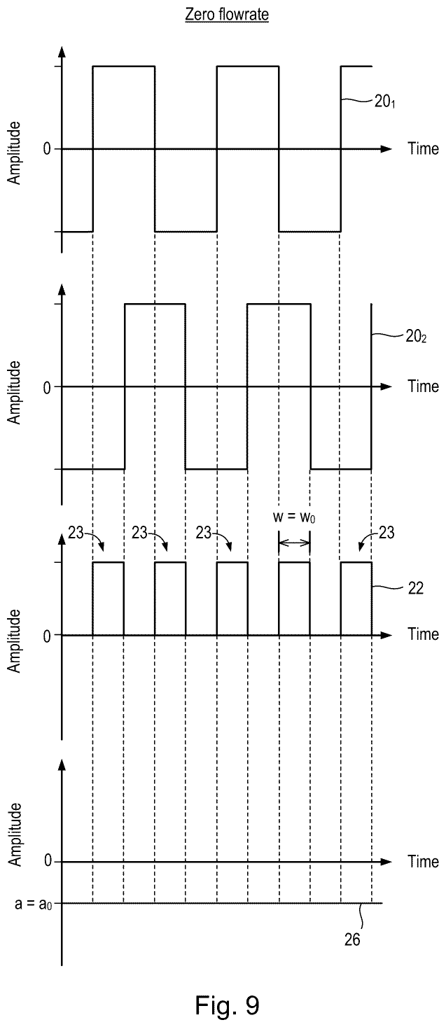

The phase difference signal 22 comprises a train of pulses 23 (FIG. 9). The width of the pulses varies according to phase difference which depends on fluid speed or velocity.

The phase difference signal 22 is provided to a bias generator 24 which includes an integrator 25 that produces a dc signal 26 whose amplitude corresponds to fluid speed or velocity. As fluid speed changes, the de signal 26 also changes and so the signal 26 can vary over time. The dc signal 26 is sampled by an analogue-to-digital converter 27 at a rate less than or equal to 128 kHz, preferably at a rate less than 1 kHz, to produce a digital signal 28 which is processed by a processor 29 in the controller 7 which may take the form of a microcontroller. The bias generator 24 and/or the analogue-to-digital converter 27 may be provided by the controller 7.

By using CW signals and sampling a slow varying dc signal 26 instead of sampling high-frequency ultrasonic wave signals 16, the circuit 6 and controller 7 can be implemented using simpler and cheaper integrated circuits.

Systems 1 and devices 5 which use the first and second arrangements will now be described in more detail.

### First Fluid Flow Measuring Device

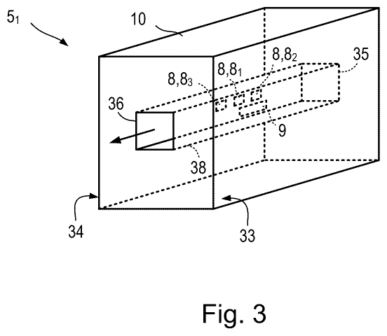

Referring to FIG. 3, a first fluid flow measuring device 5₁ has a body 10 which generally takes the form of box-like or cylinder-like structure having at least first and second sides 33, 34. The body first and second sides 33, 34 may be opposite each other, the first and second sides 33, 34 may be parallel to each other. Alternatively, the first and second sides 33, 34 may be adjacent to each other forming an angle. The angle may be less than 180°. The first and second sides 33, 34 each have a passage opening, 35, 36 and are connected by a passage 38 which passes through the body 10 to allow air (or other fluid) to flow through the body 10 of the first fluid flow measuring device 21. The first and second side openings 35, 36 may be any suitable shape, for example, square, circular or oval. The passage 38 may take the form of a pipe-like structure and may have any suitable profile, for example, square, circular, oval or hexagonal. The shape of the first and second openings 35, 36 and the profile of the passage 38 may be adapted to the location and requirements of the fluid flow measuring device.

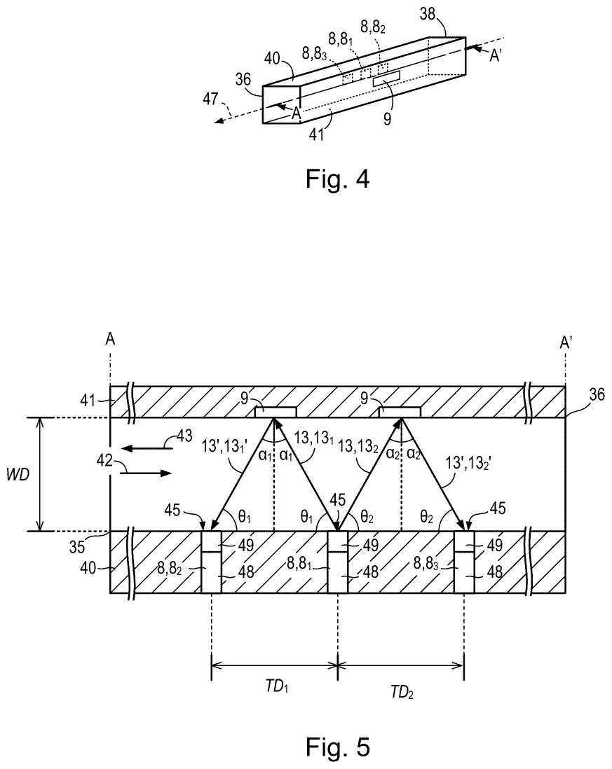

Referring also to FIG. 4, the passage 38 has first and second opposite walls 40, 41 running between the first and second passage openings 35, 36. First, second and third ultrasonic transducers 8₁, 8₂, 8₃ are arranged along the first passage wall 40. The first ultrasonic transducer 8₁ may also be referred to as “a transmitting ultrasonic transducer”, “a transmitter”, “a generation transducer”, or “a transmit transducer”. The second and third ultrasonic transducers may also be referred to as “first and second receive transducers”, “receive transducers” or “receivers”. Each of the ultrasonic transducers 8 has a respective face 45. The face 45 of each of the ultrasonic transducers 8 may be flush with the surface of the first passage wall 40. In some cases, the reflector 9 may be integrally-formed with the wall 40 as a single piece. One or more reflectors 9 are arranged on, along or alongside the second passage wall 41 to face the ultrasonic transducers 8 to reflect a pressure wave 13 (FIG. 2) emitted from the first ultrasonic transducer 8₁ to towards the second and third ultrasonic transducers 8₂, 8₃. The reflector 9 may be provided on, by or along the second passage wall 41. The reflector 9 may be flush with the second passage wall 41. Air (or other fluid) flows through the passage 38 from the first opening 35 towards the second opening 36. The first fluid flow measuring device 5₁ may have more than three ultrasonic transducers 8.

The ultrasonic transducers 8 may be arranged collinearly along the first passage wall 40 along a first axis 47. The portion of the first passage wall 40 where the ultrasonic transducers 8 are arranged may be planar around any one of the transducers. The first passage wall 40 may be planar along its whole length, from the first opening 35 to the second opening 36. The portion of the second passage wall 41 where the reflector 9 is arranged may be planar. The second passage wall 41 may also be planar along its whole length, from the first opening 35 to the second opening 36.

As will be explained hereinafter, the device 5₁ may be used in a tunnel 101 (FIG. 28) having a wall 103 (FIG. 28) and a longitudinal axis 104 runs parallel to the tunnel wall 103 (FIG. 28). The first passage axis 47 may be parallel with the longitudinal axis 104 of a tunnel 101 (FIG. 28), or parallel with the most dominant vector of airflow through the tunnel 101 (FIG. 28).

Referring also to FIG. 5, each of the ultrasonic transducers 8 comprises a transducer element 48, for example a piezoelectric transducer and a suitably-shaped transmission element 49 for directing ultrasonic pressure waves 13 from the first transducer 8₁ to the reflector(s) 8. The ultrasonic pressure waves 13 may be emitted from the second transducer 8₂ at first and second angles θ₁, θ₂ with respect to the inner surface of the first wall 40 towards the reflector(s) 9. The first and second angles θ₁, θ₂ may be between 20° and 60° and preferably between 30° and 45°. The first and second angles θ₁, θ₂ may be the same. The ultrasonic pressure waves 13₁, 13₂ are reflected by the reflector 9 as first and second reflected waves 13₁′, 13₂′ at first and second reflected angles α₁, α₂ with respect to a line perpendicular to the second fluid flow measuring device wall 41. The first and second reflected angles α₁, α₂ may be the same.

The first and second reflected waves 13₁′, 13₂′ travel to the faces of the second and third transducers 8₂, 8₃ respectively. The first and second ultrasonic transducers 8₁, 8₂ may be separated or spaced apart by a first distance TD₁, and the first and third ultrasonic transducers 8₁, 8₃ may be separated or spaced apart by a second distance TD₂. The first and second distances TD₁, TD₂ may be less than 200 mm and preferably between 50 mm to 100 mm. The first fluid flow measuring device 5₁ may have additional ultrasonic transducers (not shown) located on the same wall and spaced apart by the first and second distances TD₁, TD₂.

Air may flow in a first direction 42 from the opening 35 to the second opening 36 or in a second direction 43 from the second opening 36 to the first opening 35. The first and second walls 40, 41 are separated by given distance, for example by a known distance or a calibrated distance WD, thus, at least the relative positions between each of the first, second and third transducers are known.

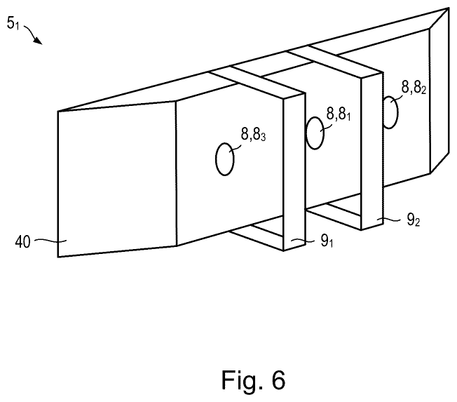

Referring to FIG. 6, the reflector 9 may take the form of first and second reflectors 9₁, 9₂ supported by the first wall 40, or surface, arranged to reflect an ultrasonic pressure wave 13 (FIG. 5) towards the second and third ultrasonic transducers 8₂, 8₃. The first and second reflectors 9₁, 9₂ may take the form of a metal bracket secured to the first wall 40. This can help reduce the number and/or area of reflective surfaces which can reduce other possible strong reflective paths between the generation transducer 81 and detection transducers 8₂, 8₃.

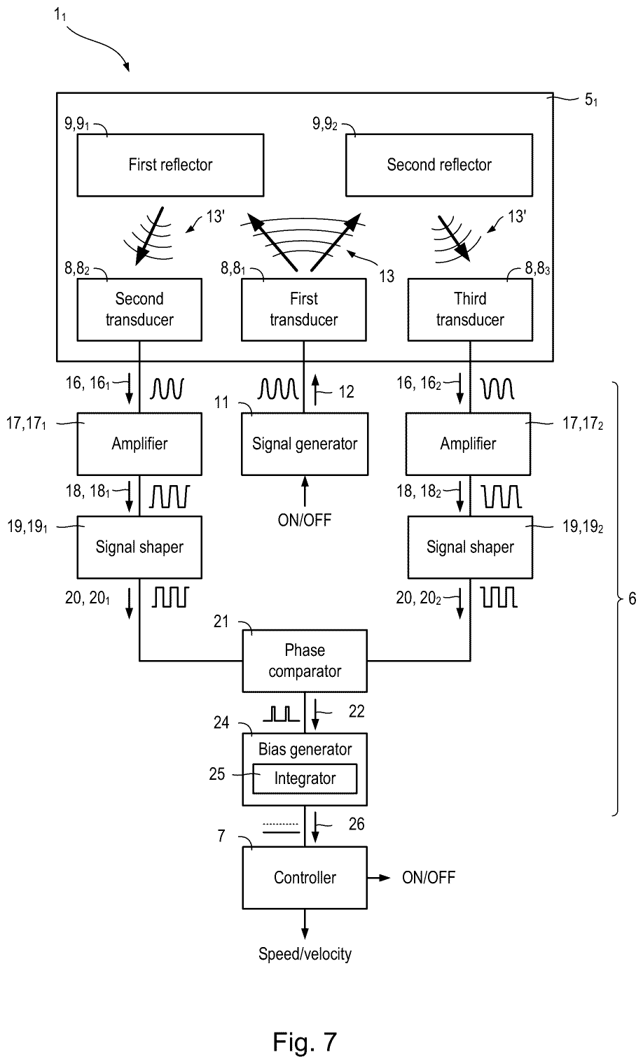

Referring to FIG. 7, a first ultrasonic flow-measuring system 11 includes the first fluid flow measuring device 5₁, the driving and measurement circuit 6 and the controller 7.

When enabled, the signal generator 11 generates a signal 12 which is supplied to the first ultrasonic transducer 8, 8₁. The first ultrasonic transducer 8, 8₁ transmits a CW ultrasonic pressure wave 13 towards the reflectors 9₁, 9₂. The ultrasonic pressure wave 13 is reflected by the reflectors 9₁, 9₂ as first and second reflected pressures waves 13₁′, 13₂′ which are directed towards the second and third ultrasonic transducers 8₂, 8₃ respectively.

The second and third ultrasonic transducers 8₂, 8₃ receive the first and second reflected ultrasonic pressure waves 13₁′, 13₂′ and generate first and second ultrasonic transducer signals 16₁, 16₂ respectively. The first and second ultrasonic transducer signals 16₁, 16₂ are amplified by first and second amplifiers 17₁, 17₂ respectively to produce first and second amplified signals 18₁, 18₂. The transducer signals 16₁, 16₂ are preferably over-amplified, i.e., saturated or “clipped”. The first and second amplified signals 18₁, 18₂ are shaped (or “conditioned”) to reduce the signal rise and fall times thereby producing first and second square wave signals 20₁, 20₂.

The first and second square wave signals 20₁, 20₂ are fed into a phase comparator 21 (or “phase detector”), for example, in the form of an XOR logic gate. The phase comparator 21 generates a signal 22 comprising a series of pulses 23 (FIG. 9). The width w of the pulses 23 are a function of the airflow velocity and so the airflow velocity is determined using the width w of the pulses 23.

Using two receive transducers 8₂, 8₃, it is possible to achieve a high accuracy airflow measurement (for example, down to velocities of 1 mms⁻¹) without using high-frequency (>128 kHz) analogue-to-digital converters (ADCs) and digital signal processors (DSPs) (which are expensive and tend to have a higher power consumption than ADCs having lower sampling rates), or a multiplexer to switch the ultrasonic transducers between sending and receiving ultrasonic signals.

The first fluid flow measuring device 5₁ may be calibrated at installation to correct for errors caused by the transducers 8₁, 8₂, 8₃. For example, the manner in which transducers 8₁, 8₂, 8₃ are fixed to or embedded in the first passage wall 40, slight variations in construction, and/or temperature variations may affect the resonant frequency of any one of the transducers, and could vary by up to 2%, or between 1 and 2%. The slight differences in the mechanical response may cause the electronic voltage signal from the second and third transducers 8₂, 8₃ to vary slightly in phase so that even at zero flow there might appear to be a flow that was not real. This zero-flow offset can also be trimmed at installation.

The location of the first, second and third ultrasonic transducers 8₁, 8₂, 8₃ on the first wall 40 can allow simplify manufacture and maintenance, and/or servicing of the device 5₁.

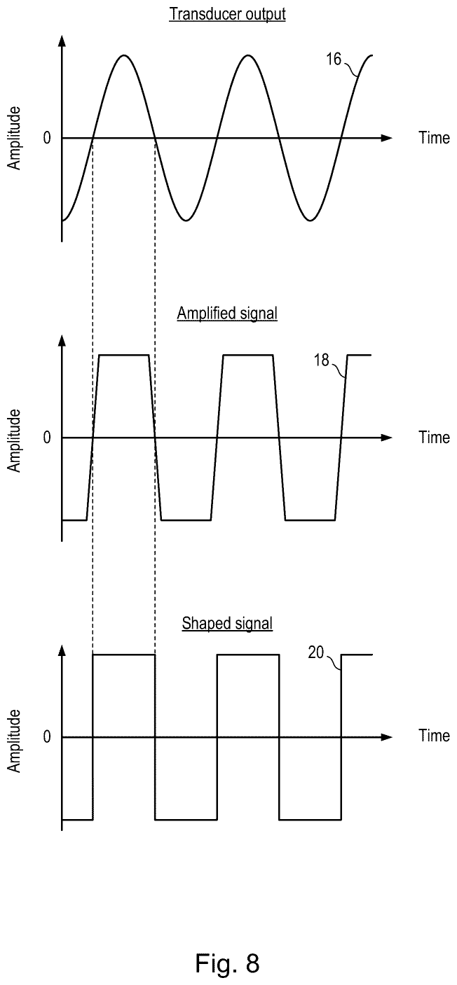

Referring also to FIG. 8, the signals 16 output by the second and third ultrasonic transducers 8₂, 8₃ have sinusoidal waveforms. The amplified or over-amplified signals 18 have generally steep, straight rising and falling edges and are clipped (i.e., saturated at a maximum and minimum values). The shaped signals 20 take the form of square-wave signals having vertical rising and falling edges.

Referring to FIG. 9, first and second shaped signals 20₁, 20₂ are compared using the phase comparator 21 (FIG. 7) which in this case takes the form of an XOR gate. When there is no flow (i.e., flowrate is zero), the first and second signals 20₁, 20₂ exhibit a constant phase offset which may be non-zero. The phase relationship between the first and second processed signals 20₁, 20₂ may be obtained using the phase comparator 21 (FIG. 7).

The phase comparator 21 (FIG. 7) generates a signal 22 which includes a train of pulses 23. The degree of phase offset is reflected by the pulse width wₒ. The bias generator 24 converts the pulsed, phase-dependent signal 22 into a bias signal 26 which has a dc offset which depends on the pulse width w. At zero flow rate, w=wₒ.

The bias generator 24 can be a low-pass filter, a loop filter or other suitable form of passive or active circuit which generates a signal whose bias depends on phase offset.

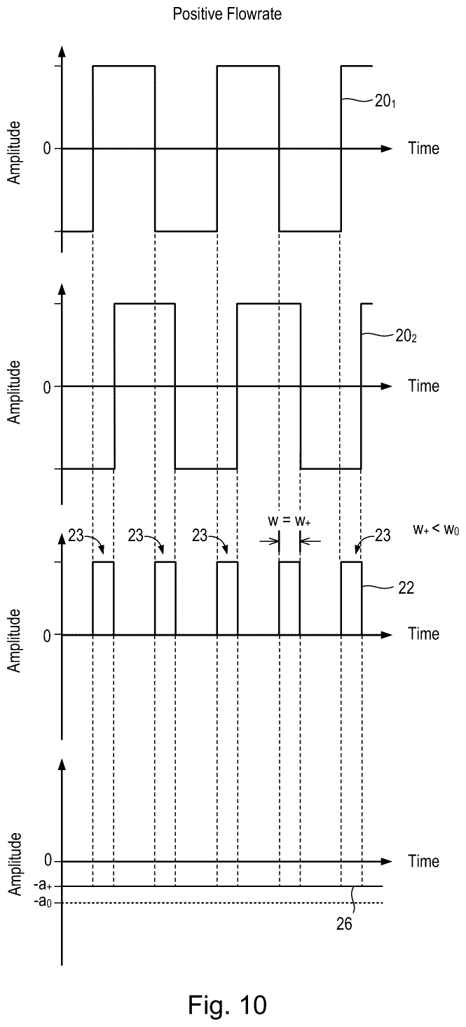

Referring to FIG. 10, as flowrate increases in magnitude a first direction 42 (FIG. 5), the first output ultrasonic pressure wave 131 and first reflected ultrasonic pressure wave 13₁′ take longer to travel from the first transducer 8₁ (i.e., the generation transducer) to the second transducer 8₂ upstream of the first transducer 8₁ than the second output ultrasonic pressure wave 13₂ and reflected ultrasonic pressure wave 13₂′ will take to travel from the first transducer 8₁ to the third transducer 8₃ downstream of the first transducer 8₁. Thus, with increasing flowrate in the first direction 42, the phase difference between the first and second signals 20₁, 20₂ decreases and the pulse width w of the phase comparator 21 (FIG. 7) decreases. Thus, at a positive flow rate, w₊<wₒ.

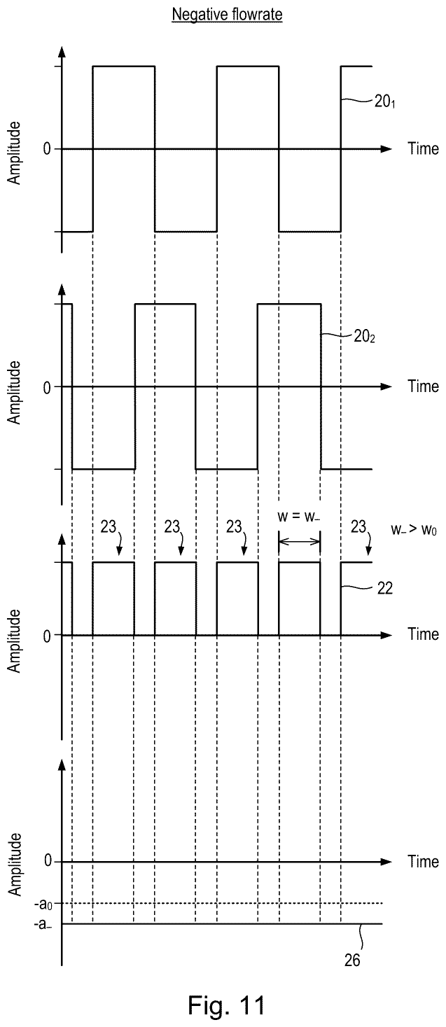

Referring to FIG. 11, when the flowrate increases in magnitude in a second, opposite direction 43, the second output ultrasonic pressure wave 13₂ and second reflected ultrasonic pressure wave 13₂′ take longer to travel from the first transducer 8₁ to the third transducer 8₃ downstream of the first transducer 8, than the first output ultrasonic pressure wave 13₁ and first reflected ultrasonic pressure wave 131′take to travel from the first transducer 8₁ to the second transducer 8₂ upstream of the first transducer 8₁. Thus, the phase difference between the first and second signals 20₁, 20₂ increases and the pulse width w of the phase comparator 21 (FIG. 7) increases. As explained earlier, the bias generator 24 (FIG. 7) generates a bias signal 26 according to the width w of the pulses 23.

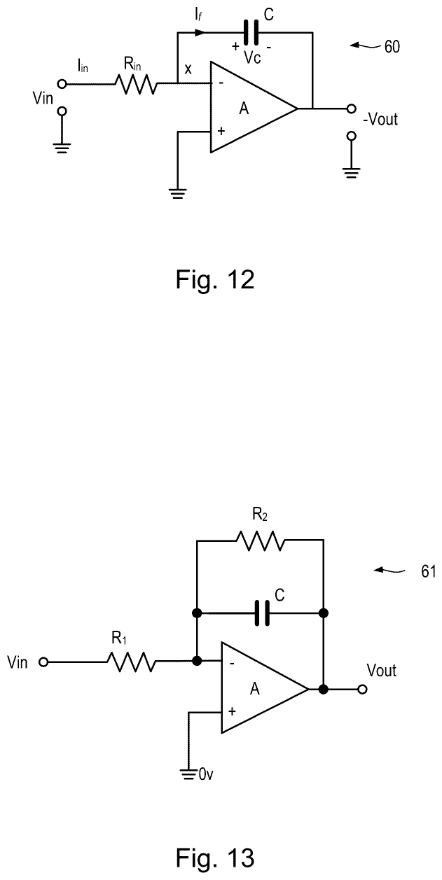

A digital counter (not shown) may be used to control the number of pulses supplied to an op-amp integrator 60 (FIG. 12), after which the output of the integrator may be read electronically and then reset. Alternatively, if a continuous or very long pulse of cycles is generated, the output of the XOR can be input to an op-amp integrator 60 (FIG. 12) with a time constant such that it delivers a continuous time averaged value of the integrated input.

Referring to FIG. 12, a first integrator circuit 60 may sum the widths of all the input pulses input to it. The integrator circuit 60 may be reset after reading the summed value for a given number of input pulses.

Referring to FIG. 13, a second integrator circuit 61 may sum the time averaged widths of all the input pulses input to it. In the second integrator circuit 61, the averaging time or time constant is determined by the capacitor and resistor in the feedback loop.

When the output 22 of the phase comparator 21 (FIG. 7) for pulses of a given fixed amplitude is integrated, the value of the integrator circuit output 26 is related to the sum of the widths w of the pulses 23. The voltage of the integrator output 26 of the integrator circuit 60, 61 can be converted to a digital value, for example, by a low-speed (i.e., with a sampling rate less than 128 kHz) analogue to digital converter 27 (FIG. 2).

To increase the dynamic range of a flowmeter, the operating frequency of the ultrasonic transducers 8₁, 8₂, 8₃ can be changed, such that the time period of the first and second signals 20₁, 20₂ supplied to the phase comparator 21 is increased.

Alternatively, the dynamic range of a flowmeter can be increased by amplitude modulating a drive signal to the generation transducer. For example, the drive signal of the first transducer 8₁ may be amplitude modulated, so that the ultrasound output 16₁ (FIG. 7) of the first transducer 8₁ is a modulated ultrasound output. The second and third transducers 8₂, 8₃ may then receive the first and second modulated reflected ultrasound waves 13₁′, 13₂′ and generate first and second modulated voltage output signals. The first and second modulated voltage output signals may then be filtered, for example, electronically filtered or filtered using suitable software, to generate two different frequency signals: a modulation frequency and an ultrasonic sound frequency. Next, two output signals with different frequencies from the second transducer 8₂ and two output signals with different frequencies from the third transducer 8₃ are generated. Signals with the same frequency will be input into an XOR gate to measure the flowrate in the same way as described earlier. If the flowrate is sufficiently high that the phase difference between the high frequency signals leads to an output signal that exceeds either the lower limit of output pulse width w (thereby causing the output pulse width w to increase beyond that point) or the higher limit of output pulse width w (thereby causing output pulse width w to decrease beyond that point), the lower frequency output signal will not have reached its limit and the high frequency output signal for the XOR gate can be used to give more accurate readings in combination with the lower frequency output signal from the other XOR gate.

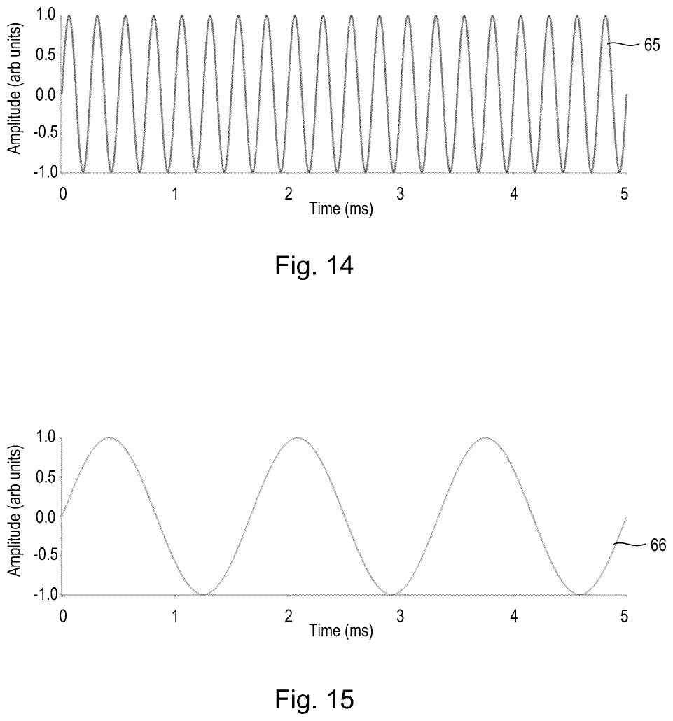

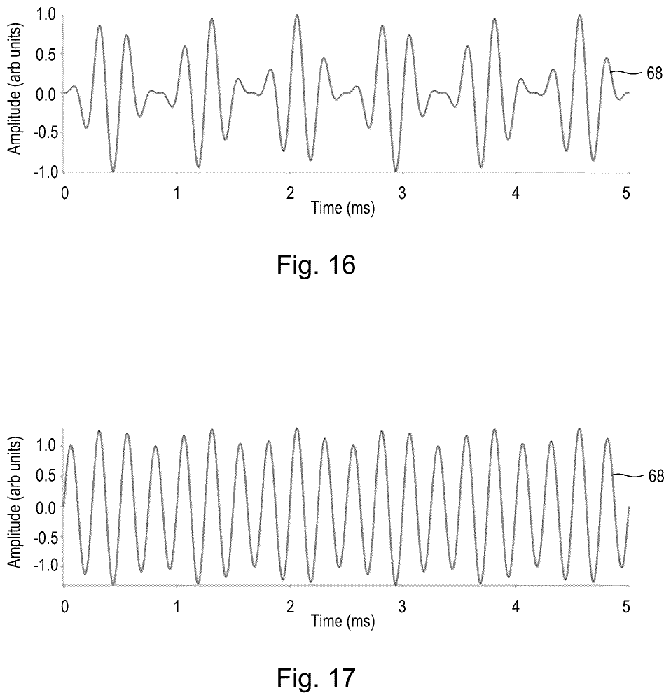

Referring to FIGS. 14 to 17, a drive signal 65 may be modulated using a modulation signal 66, for example a lower frequency signal to produce a modulated drive signal 67. When the modulated drive signal 67 is emitted from a transducer, a modulated wave 68 is generated. For illustration, the drive signal 65 has a frequency of 4 kHz (although a frequency 40 kHz would typically be used) and the modulation signal 66 has a frequency of 625 Hz.

Using a filter and amplifier to detect the low frequency modulation from the first and second signals 20₁, 20₂ output from second and third receive transducers 8₂, 8₃ it is possible to recover a signal similar to the modulation signal 66. This signal may then be amplified into a square wave of the same frequency. This process may be performed for signals travelling both upstream and downstream and the square waves from each may be fed into the phase comparator 21 (FIG. 7). It is possible to perform the same method for a higher frequency signal, for example, between 40 kHz and 68 kHz (with a time period of between 25 μs and 14.7 μs). A combination of the low-frequency integrator pulses may then be used to give the coarse measurement of flowrate over a wider range than could be achieved by using the 40 kHz signal alone. The 40 kHz signal may be used in addition to provide a more accurate measurement of flowrate using the information from the lower frequency integrated signal.

The ultrasonic transducers 8₁, 8₂, 8₃ may have a wider frequency range than mentioned above, for example, between 1 kHz and 1 MHz.

The dynamic range of the first fluid flow measuring device 5₁ can also be increased by adding additional, more closely-spaced receive transducers. Shortening the propagation distance reduces the phase shift between the signals from waves that have travelled upstream or downstream, but in doing so measurement accuracy can be reduced for lower phase shifts at lower flowrates.

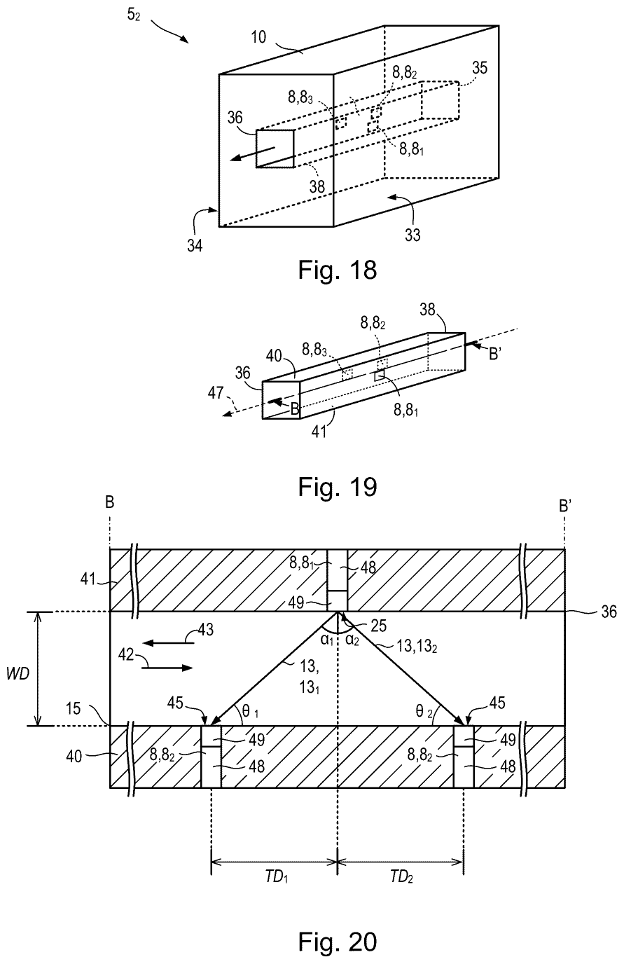

Referring to FIG. 18, a second fluid flow measuring device 5₂ is shown.

Referring also to FIGS. 19 and 20, the second fluid flow measuring device 5₂ is similar to the first fluid flow measuring device 5₁ (FIG. 3) except that the device 5₂ does not have a reflector 9 and the first ultrasonic transducer 8, is provided in its position on the second fluid flow measuring device wall 41. The first, second and third ultrasonic transducers 8₁, 8₂, 8₃ are arranged so the second and third ultrasonic transducers 8₂, 8₃ can receive a transmitted ultrasonic wave 13 directly (i.e., without reflection) from the first ultrasonic transducer 8₁.

Referring in particular to FIG. 20, the face 45 of the first ultrasonic transducer 8₁ may be flush or coplanar with the inner surface of the second wall 41. The first ultrasonic transducer 8₁ transmits an ultrasonic wave 13 towards the second and third ultrasonic transducers 8₂, 8₃ at first and second transmission angles α₁, α₂ with respect to a line perpendicular to the inner surface of the wall 41. The transmitted ultrasonic wave 13 is received at the faces 45 of the second and third ultrasonic transducers 8₂, 8₃ at first and second angles θ₁, θ₂ respectively with respect to the inner surface of the first wall 40. The first and second angles θ₁, θ₂ may be between 20° and 60° and preferably between 30° and 45°. First and second angles θ₁, α₂ may be the same. The first and second walls 40, 41 are separated by a known or calibrated distance WD, thus, at least the relative positions between each of the first, second and third transducers are known.

The second and third ultrasonic transducers 8₂, 8₃ may be closer to each other in the second fluid flow measuring device 5₂ than in the first fluid flow measuring device 5₁ (FIG. 3), allowing for a more compact device.

The second fluid flow measuring device 5₂ may be able to measure air flow speeds of up to 20 ms⁻¹ and even 30 ms⁻¹. At a speed of 20 ms⁻¹, the phase difference between the first and second ultrasonic waves 13₁, 13₂, may be π/2, to allow direction detection with the phase comparator. A frequency of 20 kHz yields a transducer separation of 18.4 mm.

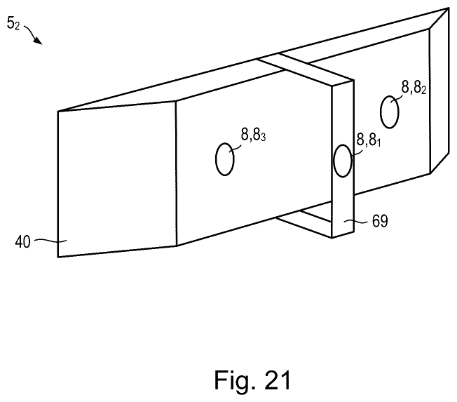

Referring to FIG. 21, the first ultrasonic transducer 8₁ can be supported by a bracket 69 (for example, a metal bracket) secured to the first wall 40. This can reduce the number of reflective surfaces which can reduce other possible strong reflective paths between the generation transducer 8₁ and detection transducers 8₂, 8₃.

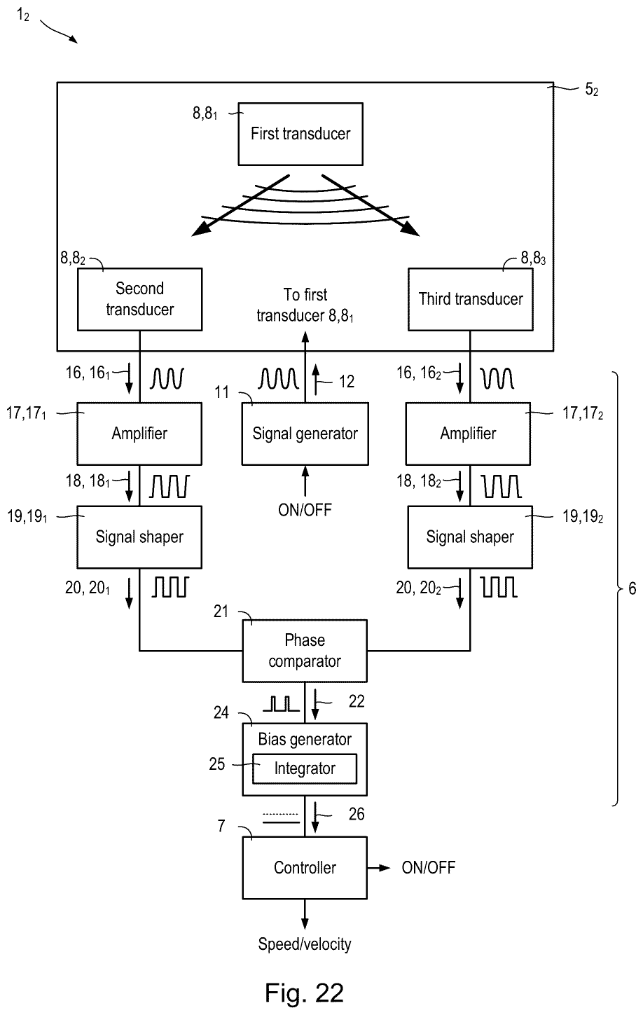

Referring to FIG. 22, the measurement circuit 6 for the second ultrasonic flow measuring-system 1₂ is the same as that used in the first ultrasonic flow-measuring system 1₁ (FIG. 7).

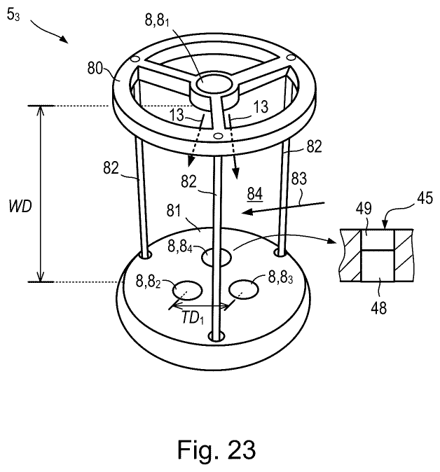

Referring to FIG. 23, a third fluid flow measuring device 5₃ includes first, second, third and fourth ultrasonic transducers 8₁, 8₂, 8₃, 8₄. The third fluid flow measuring device 5₃ is generally cylindrical in shape having first and second opposite end walls 80, 81 supported by connecting members 8₂ for example in the form of columns or struts. The third fluid flow measuring device 5₃ generally has open sides and so air 83 can flow into the space 84 between the first and second end walls 80, 81 from any direction (i.e., air is not constrained to flow in a passage).

The first ultrasonic transducer 8₁ is arranged on a first end wall 80 (or “plate”). The second, third and fourth ultrasonic transducers 8₂, 8₃, 8₄, are arranged on a second end wall 81. The first ultrasonic transducer 8₁ is arranged to transmit an ultrasonic wave towards the second, third, fourth ultrasonic transducers 8₂, 8₃, 8₄, which are in turn arranged to receive the transmitted ultrasonic wave 13.

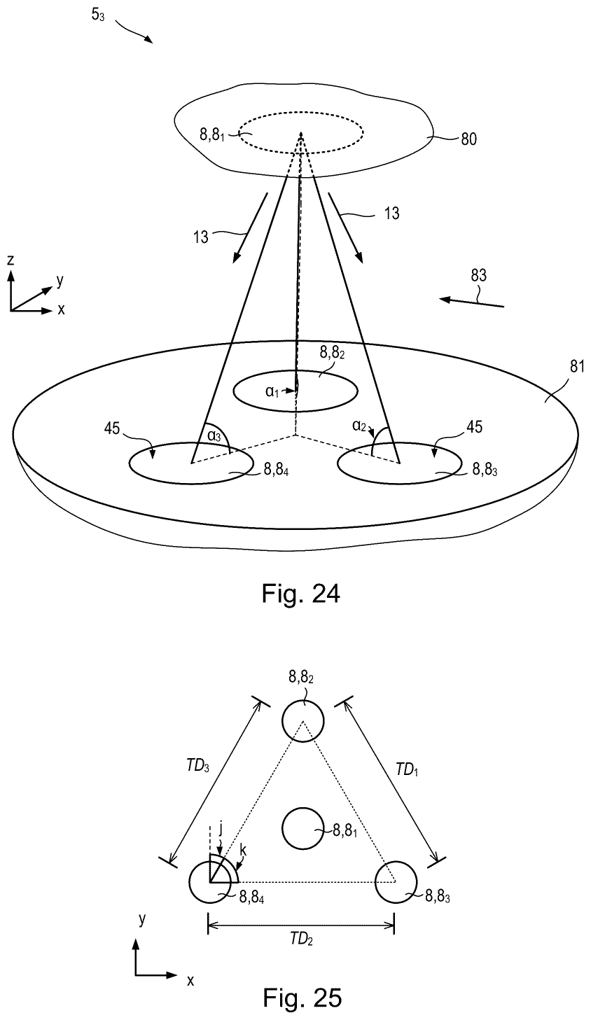

Referring to FIG. 24, the arrangement of the transducers 8₁, 8₂, 8₃, 8₄ in the third fluid flow measuring device 5₃ is similar to that in the second fluid flow measuring device 5₂ (FIG. 18). The fourth ultrasonic transducer 8₄ also has a transducer element 48 and a transmission element 49. The fourth ultrasonic transducer 8₄ is generally co-planar with the second and third ultrasonic transducers. The second, third and fourth transducers 8₂, 8₃, 8₄ are not, however, collinear. The faces 45 of the second, third and fourth ultrasonic transducers 8₂, 8₃, 8₄ may be coplanar, and may be coplanar with the surface of the end wall 8₁. The ultrasonic wave 13 transmitted by the first ultrasonic transducer 8₁ is received by the second, third and fourth ultrasonic transducers at first, second and third angles α₁, α₂, α₃, with respect to the first fluid flow measuring device wall.

Air 83 can flow over the first to fourth ultrasonic transducers 8₁, 8₂, 8₃, 8₄ in any direction and can be measured in a plane parallel to the end walls 80, 81.

The first end wall 80 which supports the first ultrasonic transducer 8₁ preferably has minimal reflective surfaces, and may only consist of support structures, e.g., a concentric annular rings and spokes, sufficient to hold the first ultrasonic transducer 8₁ in position.

Referring to FIG. 25, the second, third and fourth ultrasonic transducers 8₁, 8₂, 8₃, 8₄ may be arranged in an equilateral triangle, although any known triangle is suitable. Angle k may therefore by 60°, and angle j may be 30°. Each of the second, third and fourth ultrasonic transducers 8₂, 8₃, 8₄ are separated by a known or calibrated distance TD₁, TD₂, TD₃. The first ultrasonic transducer 8₁ may be arranged at the centre of the equilateral triangle formed by the second, third and fourth ultrasonic transducers 8₂, 8₃, 8₄. The distances TD₁, TD₂, TD₃ between the second, third and fourth ultrasonic transducers 8₂, 8₃, 8₄ are such that they are close enough to cover dynamic range of flow velocity for the fluid being measured, and the expected speed of flow.

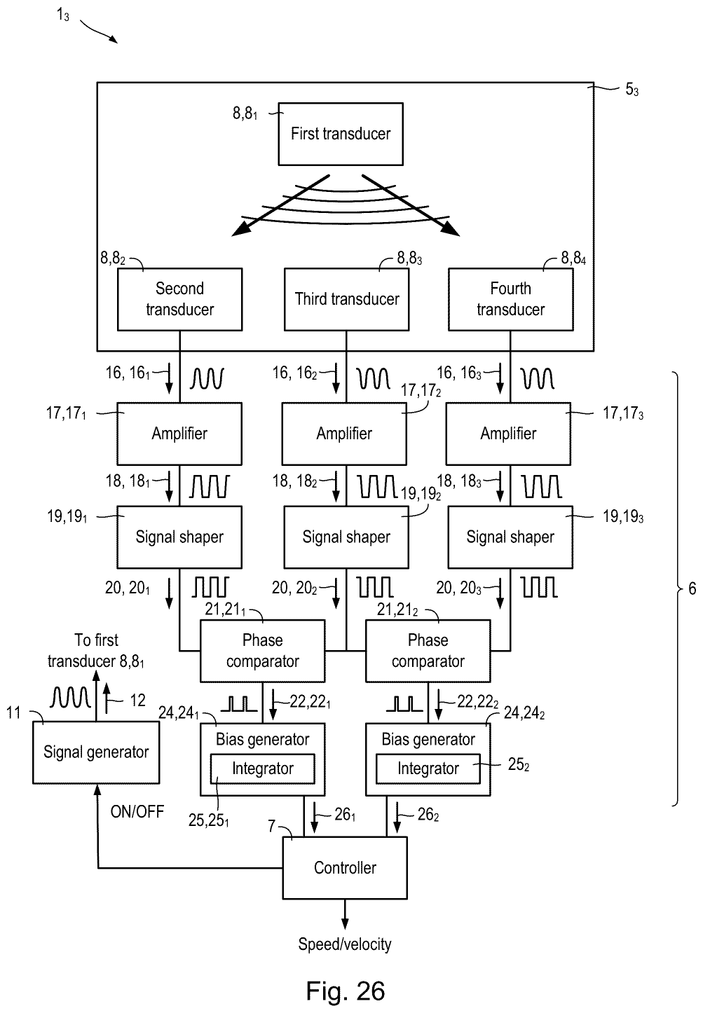

Referring to FIG. 26, a third ultrasonic flow-measuring system 1₃ includes a third fluid flow measuring device 5₃, the driving and measurement circuit 6′ and the controller 7.

The driving and measurement circuit 6′ is similar to the driving and measurement circuit 6 (FIG. 6) hereinbefore described except that there is an additional amplifier 17₃, an additional signal shaper 19₃, two phase comparators 24₁, 24₂ and two bias generators 24₁, 24₂.

The first and second square-wave signals 19₁, 19₂ are supplied to a first phase comparator 21₁ and the second and third square-wave signals 19₂, 19₃ are supplied to a second phase comparator 21₂. First and second phase-dependent signals 22₁, 22₂ are provided to respective bias generators 24₁, 24₂. Thus, the controller 7 can compute not only the speed, but also the direction of the air using flow equations and trigonometry.

### Applications

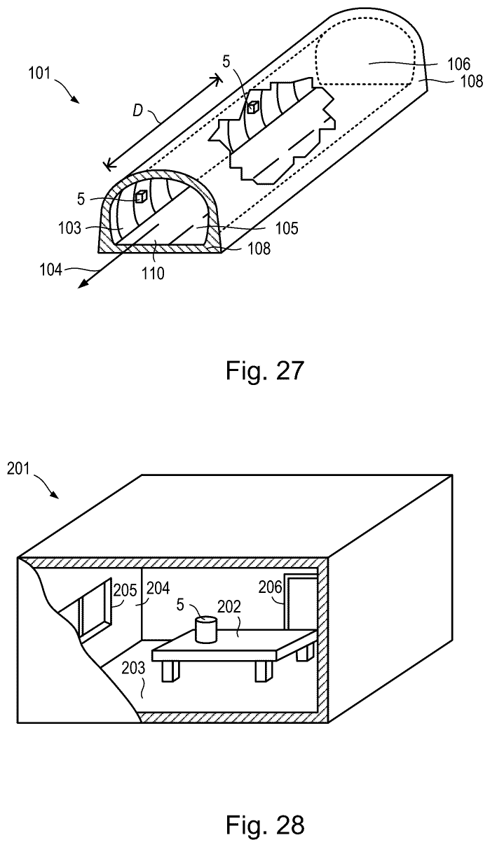

Referring to FIGS. 27 and 28, the fluid flow measuring devices 5 may be used as an anemometer in a variety of different applications. The measurement circuit 6 (FIGS. 6, 22, 27) may be provided in the same housing as the fluid flow measuring device 5, or in a separate housing and connected by a wired or wireless connection. For clarity, only the fluid flow measuring devices 5 are shown.

Referring to FIG. 27, a tunnel 101 is shown in which one or more fluid flow measuring devices 5, such as the first flow measuring device 5₁ (FIG. 2) or the second flow measuring device 5₂ (FIG. 18), is/are installed.

The tunnel 101 includes a tunnel wall 103 on which the first fluid flow measuring device 5 may be mounted. Each section of the tunnel 101 has a longitudinal axis 104 running parallel to the tunnel wall 103. Depending on the length of the tunnel, there may be more than one fluid flow measuring device 5 mounted to the wall of the tunnel, separated or spaced apart by a distance D. The tunnel has first and second openings 105, 106 located at the first and second ends 107, 108 of the tunnel 101. The distance D may be less than 200 mm and preferably between 50 mm and 100 mm.

The tunnel 101 contains air which may enter and leave the tunnel 101 through the first and second openings 105, 106. The tunnel 101 may be, for example, a road tunnel for road traffic, or a rail tunnel for rail traffic. The tunnel may have a surface 10 below the first fluid flow measuring device 5. The surface 110 may be suitable for road or rail traffic.

Referring to FIG. 28, a room 201 is shown in which one or more fluid flow measuring devices 5, such as the third flow measuring device 5₃ (FIG. 23), is/are installed.

The fluid flow measuring device 5 may be placed, for example, on a table 202, shelf (not shown) or stand (not shown), or on the floor 203, or mounted to a wall 204 or ceiling (not shown), and may be used to identify whether there is sufficient ventilation in the room 201 (or other similar space).

The device 5 may be used to provide information about effectiveness of measures to limit airborne transmission of pathogens, such novel coronavirus (COVID-19), and/or to provide sufficient ventilation.

The device 5 may be linked to a warning device (not shown) which may trigger a warning message if air flow speed drops below a threshold value. The warning device may, for example, may emit an audible alarm and/or transmit a warning message to a phone, which can inform the room occupants or a facilities manager to take appropriate measures, for example, to open a window 205 or door 206 or increase speed of an air conditioning unit (not shown).

The flow measuring device 5 may be used in a conduit of an air conditioning system (not shown) for measuring air flow.

### Modifications

It will be appreciated that various modifications may be made to the embodiments hereinbefore described. Such modifications may involve equivalent and other features which are already known in the design and use of fluid flow measuring devices, flow measuring systems and component parts thereof and which may be used instead of or in addition to features already described herein. Features of one embodiment may be replaced or supplemented by features of another embodiment.

Other circuits for measuring phase difference can be used. For example, other logic gate configurations (other than used XOR gates) can be used. Further ultrasonic transducers may be provided. Further amplifiers may be provided. Further signal shapers may be provided. Further phase comparators and corresponding dc bias generators may be provided.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. Apparatus comprising:
first, second and third ultrasonic transducers, the second and third ultrasonic transducers arranged to receive an ultrasonic wave from the first ultrasonic transducer, wherein the second and third ultrasonic transducers are spaced apart by a given distance; and
a circuit comprising a phase comparator arranged to compare first and second signals from the second and third ultrasonic transducers.

2. The apparatus of claim 1, further comprising:
a signal generator, coupled to the first ultrasonic transducer, configured to cause the first ultrasonic transducer to generate a continuous-wave ultrasonic wave.

3. The apparatus of claim 1, further comprising:
a fourth ultrasonic transducer arranged to receive an ultrasonic wave from the first ultrasonic transducer, wherein the fourth ultrasonic transducer is spaced apart from the second ultrasonic transducer by a given distance and is not collinear with the second and third ultrasonic transducers;
the circuit further comprising a further phase comparator arranged to compare the first signal and a third signal from the fourth ultrasonic transducer.

4. The apparatus of claim 3, wherein the second, third and one of the fourth ultrasonic transducers are arranged in an equilateral triangle.

5. The apparatus of claim 1, further comprising a respective amplifier for each of the second, third and fourth ultrasonic transducers, each amplifier configured to amplify the signal from the respective ultrasonic transducer having a gain set to saturate the signal.

6. The apparatus of claim 1, further comprising
a controller, the controller optionally comprising a signal generator configured to generate a signal for transmission by the first ultrasonic transducer.

7. The apparatus of claim 1, wherein the circuit is configured
to convert ultrasonic wave signals from the second, third and, optionally, fourth ultrasonic transducers into square wave signals; and
to generate a series of pulses by comparing two of the square wave signals.

8. The apparatus of claim 7, wherein determining the speed or velocity of fluid moving past the second, third, and fourth ultrasonic transducers is based on the widths of the pulses.

9. The apparatus of claim 7, wherein the circuit is further configured to generate a dc voltage output based on the width of pulses from the output of a logic gate used to measure the phase difference between two received signals.

10. The apparatus of claim 1, further comprising a plurality of sets of ultrasonic transducers, each comprising a first, second, third ultrasonic transducer.

11. An apparatus comprising:
a surface comprising first, second and third ultrasonic transducers arranged along the surface having respective transducer faces which are flush with the surface;
a first reflector supported by the surface arranged so as to reflect a pressure wave emitted by the first ultrasonic transducer towards the second ultrasonic transducer; and
a second reflector supported by the surface arranged so as to reflect a pressure wave emitted by the first ultrasonic transducer towards the third ultrasonic transducer.

12. The apparatus of claim 11, wherein the first, second and third ultrasonic transducers are arranged collinearly.

13. The apparatus of claim 12, wherein the collinear line that joins the transducers is arranged to be parallel with a longitudinal axis of a tunnel.

14. The apparatus of claim 11, further comprising:
a circuit operatively connected to the second ultrasonic transducer; and
first and second amplifiers connected to the first and third ultrasonic transducers respectively.

15. The apparatus of claim 14, wherein the circuit further comprises first and second signal shapers arranged to receive first and second amplified signals from the first and second amplifiers respectively to generate first and second square waves respectively.

16. The apparatus of claim 14, further comprising
a phase comparator operatively connected to the first and third ultrasonic transducers, the first and second amplifiers, or to the first and second signal shapers.

17. A method of determining speed and/or direction of a fluid flow, the method comprising:
causing transmission or transmitting an ultrasonic wave from a first ultrasonic transducer towards a second, third and, optionally, fourth ultrasonic transducers; and
obtaining speed or velocity by comparing phase difference between first and second ultrasonic wave signals from a first pair of the second, third and/or fourth ultrasonic transducers and, optionally, by comparing phase difference(s) between first and second ultrasonic wave signals from a second pair of the second, third and/or fourth ultrasonic transducers.

18. The method of claim 17, wherein obtaining the speed and/or direction of the fluid flow further comprises:
for the first and second ultrasonic wave signals, converting ultrasonic wave signals from the second, third and, optionally, fourth ultrasonic transducers into first and second square wave signals; and
generating a first series of pulses by comparing the first and second square wave signals of the first pair of ultrasonic transducers and, optionally, generating a second series of pulses by comparing the first and second square wave signals of the second pair of ultrasonic transducers.

19. The method of claim 18, wherein the first or second series of pulses are generated by applying exclusive OR logic on the first and second square wave signals of the first pair of ultrasonic transducers and, optionally, on the first and second square wave signals of the second pair of ultrasonic transducers.

20. The method of claim 18, wherein determining the speed or velocity of fluid moving past the second, third and, optionally, fourth ultrasonic transducers is based on the widths of the pulses.

21. The method of claim 18, further comprising generating a dc voltage output based on the rate of pulses in the first or second series of pulses.
